(19) United States
(12) Patent Application Publication
(10) Pub. No.: US 2026/0174271 A1
(43) Pub. Date: Jun. 25, 2026

(54) Automated System And Method For Preparing Customizable Beverages

(71) Applicant: XOXO Beverages Limited, Hong Kong (HK)

(72) Inventors: Sin Tak Yau, Hong Kong (HK); Ka Lok Chan, Hong Kong (HK)

(21) Appl. No.: 19/418,925

(22) Filed: Dec. 13, 2025

(30) Foreign Application Priority Data
Dec. 19, 2024 (HK) 32024101118.0

(51) Int. Cl. A47J 31/40; B67D 1/00

(52) U.S. Cl. CPC A47J 31/407; B67D 1/0021; B67D 1/0034; B67D 1/0041

(57) ABSTRACT

The invention relates to an automated system for preparing customizable beverages, comprising: an ingredient module for receiving ingredients, the ingredient module comprises receptacles for adaptively receiving and positioning respective ingredient containers of the ingredients; a dispensing module fluidly connectable with the ingredient module, configured to automatically dispense a predetermined amount of one or more selected ingredients into a designated beverage container based on a selected recipe; a mixing module for securely engaging and positioning the designated beverage container, comprising a rotating unit adapted to rotate the engaged and positioned beverage container at a predetermined speed of rotation under a predefined spin curve, thereby mixing the dispensed selected ingredients to form a beverage in the beverage container according to the selected recipe; and a processing module configured to control operation of the dispensing module and/or the mixing module thereby providing real-time customizations to the selected recipe based on user instructions.

### FIELD OF THE INVENTION

The invention relates to the field of automated preparing and dispensing of beverages. Particularly, but not exclusively, the invention relates to an automated system and method for preparing a range of customizable beverages, such as but not limited to, cocktail beverages.

### BACKGROUND OF THE INVENTION

Traditionally, crafting beverages such as cocktails has been a manual process that relies heavily on the expertise of a skilled bartender. However, the manual nature of mixing drinks can be intricate and time-consuming, often resulting in inefficiencies and high labor costs that contribute to the overall expense of cocktails. With the large variety of mixing techniques and recipes available for cocktail beverages, the diverse approaches to preparation can inadvertently introduce errors, leading to inconsistencies in both the taste and overall quality of the drinks produced.

In today's fast-paced world where convenience and speed are paramount, there is a growing need for innovation in the realm of cocktail preparation. Various automated beverage systems have been developed to offer solutions with improved consistency and efficiency that surpasses traditional manual methods. For example, coffee makers and beverage machines have been introduced to homes, offices, and commercial settings, offering a basic level of automation for brewing coffee, tea, and other beverages. However, existing technologies in automated beverage making systems often exhibit limitations and insufficiencies that impede optimal user experience. Particularly, conventional automated systems are designed for specific beverages with limited number of preset recipes, limiting options for customization in terms of strength and flavor profile, thus restricting creativity in drink choices. Furthermore, existing technologies predominantly consist of semi-automated systems which necessitate human intervention for both setup, operation and maintenance.

In light of these challenges, there is a growing demand for an automated beverage making system that addresses these deficiencies and introduces advancements to enhance user experience, offer a broader range of beverage options and streamline operation.

### OBJECTS OF THE INVENTION

An object of the present invention is to provide an automated system and method for preparing beverages.

Another object of the present invention is to provide an automated system and method for preparing customizable beverages, including but not limited to, cocktail beverages.

A further objection of the present invention is to provide an automated system and method for preparing customizable beverages which is adapted to evaluate or predict characteristics of the beverages.

A yet further object of the present invention is to mitigate or obviate to some degree one or more problems associated with known beverage making systems, or at least to provide a useful alternative.

The above objects are met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides an automated system for preparing customizable beverages. The system comprises an ingredient module for receiving one or more ingredients, the ingredient module comprises one or more receptacles for adaptively receiving and positioning respective ingredient containers of the one or more ingredients; a dispensing module fluidly connectable with the ingredient module, the dispensing module is configured to automatically dispense a predetermined amount of one or more selected ingredients from the one or more ingredients into a designated beverage container based on a selected recipe; a mixing module for securely engaging and positioning the designated beverage container, the mixing module comprises a rotating unit adapted to rotate the engaged and positioned beverage container at a predetermined speed of rotation under a predefined spin curve, thereby mixing the dispensed selected ingredients to form a beverage in the beverage container according to the selected recipe; and a processing module configured to control operation of the dispensing module and/or the mixing module thereby providing real-time customizations to the selected recipe based on user instructions.

In a second main aspect, the invention provides a method of automatically preparing customizable beverages according to the first main aspect. The method comprises the steps of receiving one or more ingredients via an ingredient module; according to a selected recipe, engaging and positioning a designated beverage container via a mixing module; dispensing automatically, via a dispensing module fluidly connectable with the ingredient module, a predetermined amount of one or more selected ingredients from the one or more ingredients into the designated beverage container based on the selected recipe; mixing, via a mixing module, the dispensed selected ingredients by rotating the engaged and positioned beverage container at a predetermined speed of rotation under a predefined spin curve, thereby forming a beverage in the beverage container according to the selected recipe; and wherein the dispensing step and/or the mixing step are customizable in real-time via a processing module based on user instructions.

In a third main aspect, the invention provides a computer-implemented method of evaluating characteristics of a beverage. The method comprises providing a database of one or more recipes, wherein each recipe comprises a preset ratio of one or more ingredients; assigning to each of the one or more ingredients corresponding values representing respective one or more visual characteristics and/or sensory characteristics of said ingredient; computing overall values representing the respective visual characteristics and/or the sensory characteristics of a beverage to be formed based on a selected recipe; and outputting a profile information of the beverage to be formed based on the computed overall values.

In a fourth main aspect, the invention provides a computer-implemented system of evaluating characteristics of a beverage. The system comprises a memory for storing data and a processor for executing computer readable instructions, wherein the processor is configured by the computer readable instructions when being executed to implement the method according to the second or the third main aspect.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a block diagram showing the technical configuration of the automated system for preparing beverages according to an embodiment of the present invention;

FIG. 2 is a schematic diagram showing the perspective view of the automated system of FIG. 1;

FIG. 3 is a schematic diagram showing the exploded view of the automated system of FIG. 2;

FIG. 4A is a schematic diagram showing the gripping unit in a close position of the automated system of FIG. 2;

FIG. 4B is a schematic diagram showing the gripping unit in an open position of the automated system of FIG. 2;

FIG. 5 is a schematic diagram showing operation of the dispensing module and the mixing module of the automated system of FIG. 2;

FIG. 6A shows an embodied view of the user menu displayed at the user input unit of the automated system of FIG. 2;

FIG. 6B shows an embodied view of the user menu of the automated system of FIG. 2 displaying the appearance and taste profile of a beverage;

FIG. 7 is a flow diagram showing operation of the pumping unit for a controlled dispensing by the automated system of FIG. 1;

FIG. 8 is a flow diagram showing operation of the gripping unit for adaptive gripping of a beverage container by the automated system of FIG. 1;

FIG. 9 is a flow diagram showing operation of the rotating unit to provide vortex mixing of the dispensed ingredients by the automated system of FIG. 1;

FIG. 10 is a flow diagram showing the customization workflow by the automated system of FIG. 1;

FIG. 11 is a flow diagram showing operation of the predictive unit by the automated system of FIG. 1;

FIG. 12 is a flow diagram showing the data analytics by the automated system of FIG. 1; and

FIG. 13 is a flow diagram showing a method of preparing customizable beverages via the system of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The functions of the various elements or components shown in the figures may be provided through the use of dedicated software, hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

The present invention relates to an automated system and method for preparing beverages. Particularly but not exclusively, the present invention relates to an automated system for preparing beverages by mixing multiple ingredients, with such beverages may include, but are not limited to, cocktail beverages. The system operates in a fully automatic manner, achieving precise and synchronized dispensing of the individual ingredients according to preset or adjustable recipes. The system features containers adaptation to facilitate optimal glass gripping and positioning for dispensing and blending of ingredients, allowing an effective vortex mixing of the diverse ingredients by controlled rotation of the container specific to the selected cocktail recipe to form a cocktail readily mixed in the serving glass. The system further allows automation to customize the recipes in real-time, allowing on-the-fly adjustments to ingredients and preparation parameters through an interactive user interface. More particularly, the system is adapted to predict various characteristics, such as visual and/or sensory attributes of the prepared beverages, whether following the standard recipes or the customized variations. In one embodiment, the system further provides visual depictions of the prepared beverages which enhances the user experience by offering a preview of the final product. The system therefore allows accurate forecasting and visualization of the beverages to be created, facilitating recipes customization, flavors experimentation, visual enhancements of beverage presentation, as well as personalized offerings tailored for specific customers or events.

While the embodiments herein described have detailed the preparation of cocktail beverages as examples, a person skilled in the art will appreciate that the present invention shall not be restricted to the application of cocktail making alone. Instead, any beverage preparation which may involve blending or mixing of one or more ingredients, shall also be encompassed by the present invention, as long as these applications do not depart from the inventive concept of the present invention.

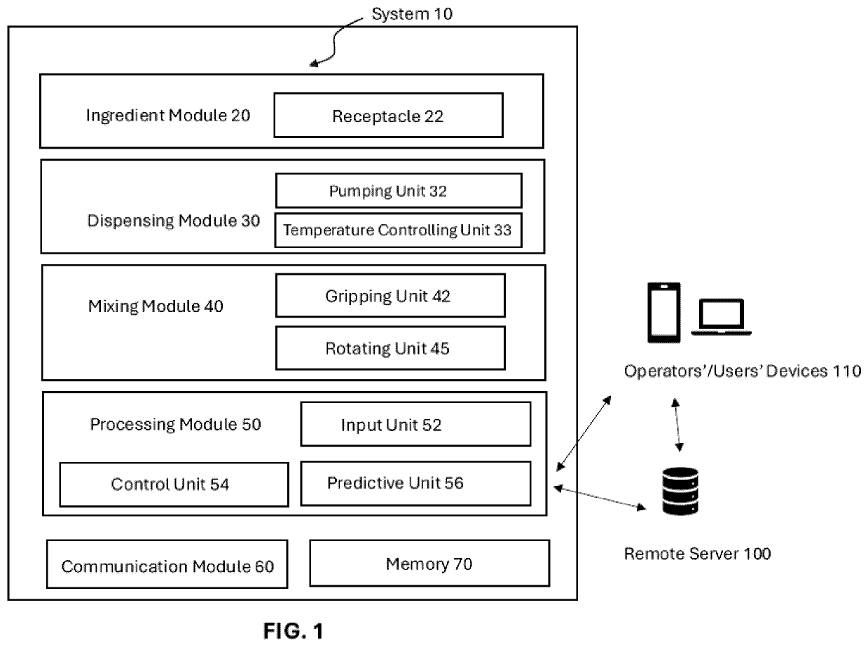

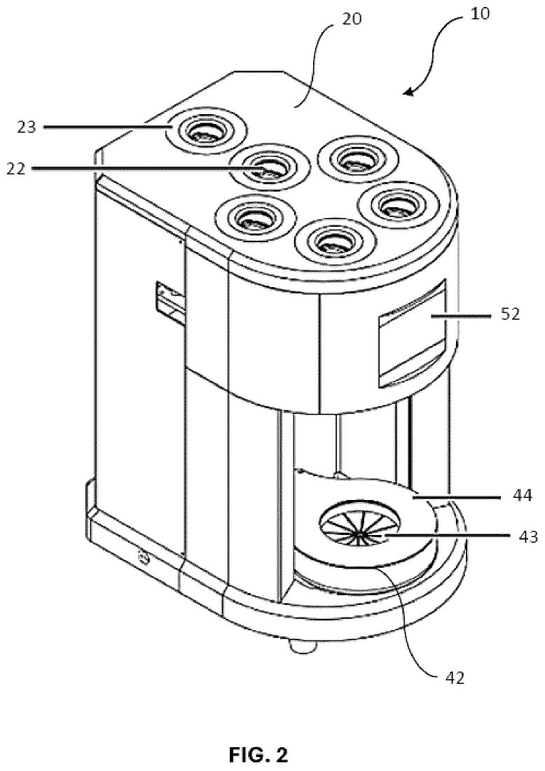

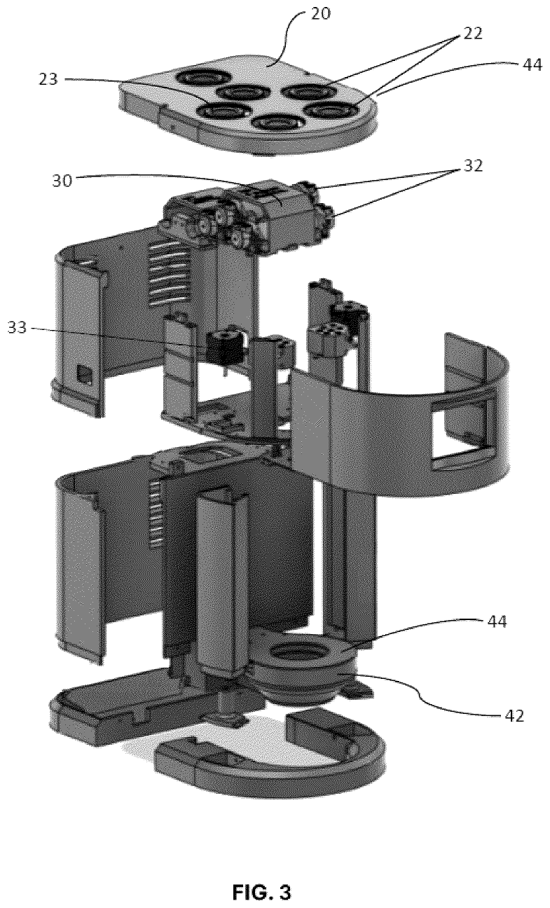

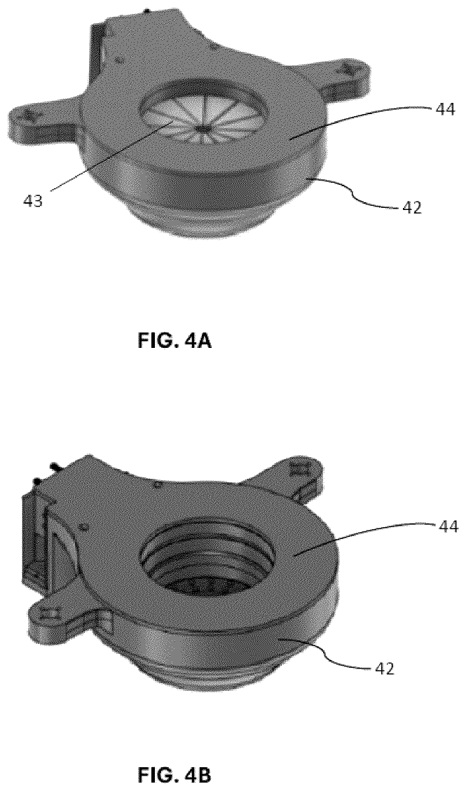

Referring to FIG. 1, shown is the technical implementation of the automated system 10 for preparing customizable beverages according to an embodiment of the present invention. The system 10 comprises an ingredient module 20 adapted to receive one or more ingredients, which may include various forms of liquids such as juices, syrups, carbonated or non-carbonated, alcoholic or non-alcoholic; powders; semi-liquids such as fruit purees or jellies; gases such as carbon dioxide or nitrogen; and/or other elements such as fresh fruits, herbs, edible flowers, spices, ice cubes or other decorative garnishes. As more clearly illustrated in FIGS. 2 and 3, the ingredient module 20 preferably comprises one or more receptacles 22 for adaptively receiving and positioning the respective ingredient containers, such as bottle containers of the liquid ingredients. These receptacle 22 are configured to provide a secure, substantially leak-proof and air-tight receiving port for the ingredients as they enter the system 10. In one embodiment, the ingredient module 20 may feature a plurality of receptacles 22 of the same or varying sizes and/or shapes to accommodate different types of ingredients and containers of the ingredients. In one preferred embodiment, the ingredient module 20 preferably comprises 4-8 circular receptables strategically positioned as inlets for receiving the openings of the bottle containers of the ingredients. The receptacles 22 in their specific layout not only supports the bottle containers but also ensures their stable positioning within the system 10 for operational efficiency and ingredient management within the automated beverage preparation process.

The bottle containers can be securely affixed at the receptacles 22 through a range of established mechanical locking mechanisms, such as by friction locking, where the bottle is held by friction between its exterior and the interior wall of the receptacle; twist locking whereby rotating of the bottle relative to the receptacle to engage or disengage it from the receptacle; notch locking which employs specific notches or grooves at the bottle and/or the receptacle for secure attachment; snap locking by swiftly snapping the bottle into place at the receptacle. Other options include various releasable latch mechanisms which may provide releasable securing of the container at the receptacle 22. In one specific embodiment, receptacle 22 may comprise a valve component to regulate the unidirectional flow of liquid therethrough. In another embodiment, an adaptor can be arranged at the container to interface with the receptacle 22, facilitating a sealed, liquid-proof and air-tight connection between the container and the receptacle 22. The adaptor may further be designed with a valve or similar device to control the flow of liquid from the bottle to the receptacle 22 effectively.

In one specific embodiment, the receptacle 22 may further be equipped with a visual and/or audible indicator 23, such as a light indicator and/or a buzzer, signaling when the bottle is securely located in place at the receptacle 22. This indicator serves to provide a clear signal to the user, indicating that the ingredients are ready for dispensing.

Optionally, the ingredient module 20 may comprise one or more interconnectable submodules, such as one or more extensions comprising additional sets of receptacles connectable to the main ingredient module for accommodating an expanded array of ingredients as required.

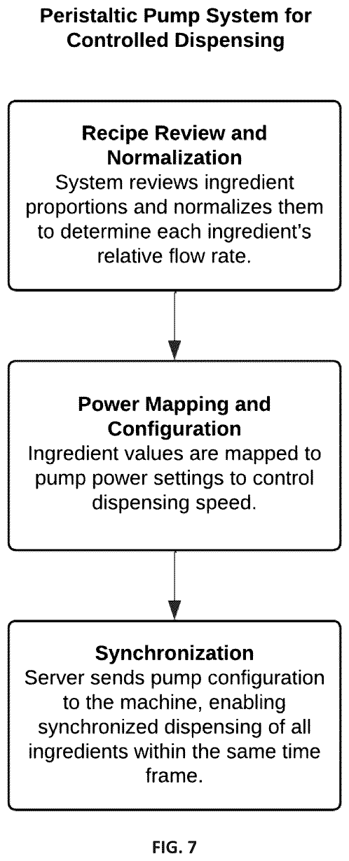

The system 10 further comprises a dispensing module 30 fluidly connectable with the ingredient module 20, such as via various tubings or passageways. The dispensing module 30 is configured to automatically dispense precise and predetermined amounts of selected ingredients from the received ingredients into a designated beverage container, guided by a user-selected recipe. Particularly, the dispensing module 30 comprises one or more independently operated pumping units 32, each configured to dispense the respective selected ingredients at corresponding flow rates aligned with the selected recipe. Preferably, these pumping units 32 functions by executing synchronized peristaltic pumping action to concurrently dispense the selected multiple ingredients with exceptional precision in flow rates, timing and sequence, ensuring exact volume measurements, maintaining ingredient ratios accurately. This synchronous dispensing guarantees consistent quality across all beverage preparations, facilitating the creation of complex beverages including visually captivating, layered beverages that enhance the overall aesthetic appeal for the customer. The pumping units 32 are tailored to dispense liquids of varying viscosities and conditions, such as viscous syrups and carbonated ingredients. The peristaltic pumping action further assists in directing a unidirectional flow of the selected ingredient towards the beverage container. An embodied workflow of the peristaltic pumping action of the dispensing module 30 is further shown in FIG. 7, which involves the system 10's analyzing of ingredient ratios or proportions, normalizing them to determine relative flow rates for each ingredient, mapping of ingredient values to the power settings of the pumping units 32 to regulate the dispensing speed, and subsequently, receiving pumping configuration from a remote server 100 to execute the synchronized dispensing of all ingredients simultaneously.

Optionally, the dispensing module 30 may further comprise a temperature controlling unit 33. The temperature controlling unit 33 may comprise one or more heating unit and/or cooling unit to preheat and/or precool selected one or more ingredients from ambient temperature to a preset, tasting temperature prior to dispensing.

Preferably, the system 10 provides a selection of preset beverage recipes for customers, which can be conveniently presented through an interactive input unit 52, such as a user-friendly touch screen interface 52. These recipes not only outline the ingredients for making the beverage and their ratios or proportions, but also detail the mixing techniques, suggested garnishes, preferred glassware to be used, as well as serving instructions. In one embodiment, the system 10 may comprise a database stored at a local server or remote server 100, such as a cloud-based server which comprise a large variety of beverage recipes. These recipes can be readily accessed by system operators or customers for selection via the interactive input unit 52 provided at the system 10. Alternatively, users can remotely select recipes using computer or mobile devices 110 via web-based or mobile applications, with their instructions being communicated in real-time to the system 10 via a wireless network. This versatile setup allows for a dynamic operation to the system 10, enabling users to engage with the beverage selection process both on-site and from remote locations, enhancing convenience and personalization in the beverage ordering or customization process.

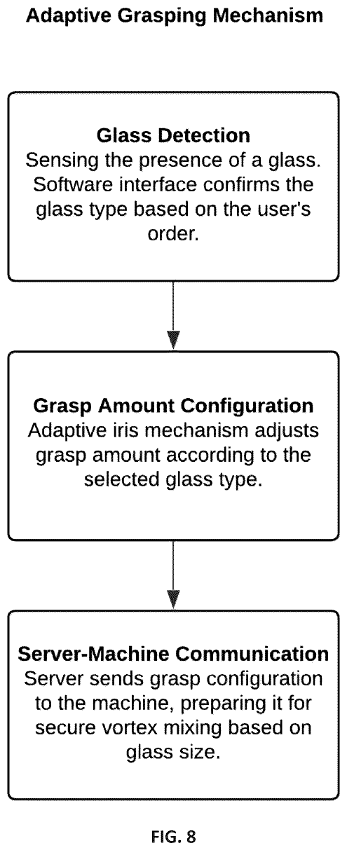

The system 10 further comprises a mixing module 40 adapted to securely engage and positioning the designated beverage container in alignment with the customer's chosen recipe. The mixing module 40 is adapted to automatically adjust the positioning of the beverage container by moving along one or more axes, such as the x-axis for horizontal movement, the y-axis for vertical adjustment, and/or the z-axis for forward and backward shift relative to the dispensing module 30 to ensure precise alignment for receiving the dispensed ingredients. Particularly, the mixing module 40 comprises a gripping unit 42, also referred to as the “iris mechanism”, configured to automatically and snugly grip onto the designated beverage container based on its shape and/or dimension. In one embodiment, the gripping unit 42 is configured to comprise a set of movable segments 43 extending radially from a substantially circular frame 44. At the centre of the segments 43, it is defined thereby an aperture where the container is placed and positioned. In use, these segments 43 are movable automatically between an open position—where they retract radially outwardly towards the frame 44 to expand the aperture for receiving the container; and a close position—where they extend radially inwardly towards the centre of the frame 44, constricting the aperture thereby firmly grasping the container in place. Preferably, movement of the segments 43 is controlled to apply varying degrees of grip strength, ensuring stable and secure positioning tailored to different types of glassware or container. This adaptive iris mechanism eliminates the need for additional attachments, adaptors, or manual adjustments, offering compatibility with a diverse range of glass types, sizes and shapes. To protect the glassware from potential scratches and to optimise gripping efficiency, the segments 43 are preferably formed of resilient or flexible materials. This approach not only safeguards the glassware but also enhances the friction required for a secure grip. An embodied gripping mechanism's workflow is further shown in FIG. 8, comprising the determination of the glass type based on the user's order by a software interface, the automatic adjustment of grip strength by the adaptive iris mechanism according to the selected glass type, and the subsequent transmission of grasp configuration instructions from the server to system 10, preparing it for secure vortex mixing tailored to the specific glass size, which will be discussed further below.

The automated gripping mechanism and the adaptive positioning of glassware play a pivotal role in the seamless operation of the system 10, particularly during the subsequent mixing stages. As different glassware is designed for and thus preset at the recipe for different beverages, a specific glassware type will be designated once a recipe is selected by the user customer. Different glassware comes with different designs in terms of shapes and dimensions, and therefore it is important for the mixing module 40 to automatically adjust and stabilize the positioning of the designated glassware, such that the subsequent dispensing and mixing steps can be conducted without spillage or damage of the glassware.

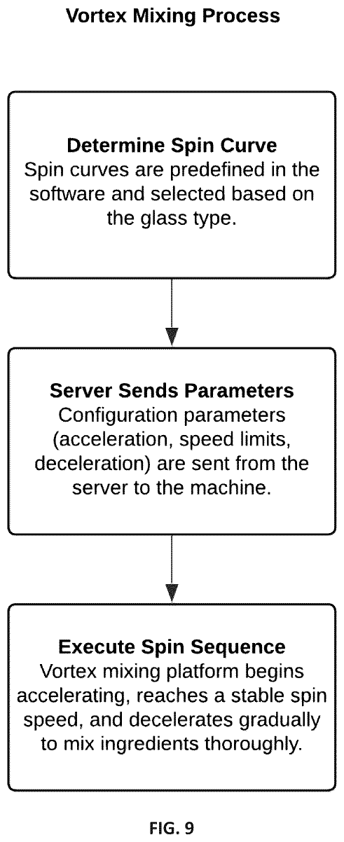

More preferably, the mixing module 40 comprises a rotating unit 45 configured to rotate the engaged beverage container at a controlled, predetermined speed following a predefined spin curve. This rotational motion facilitates a thorough mixing of the dispensed ingredients, aligning with the selected recipe to craft the beverage readily in the serving container. The specifically calibrated speed of rotation and spin curve, along with the unique shape and dimension of the designated glassware, create a vortex mixing of the dispensed ingredient in the container, which promote effective blending of ingredients across various recipes to enhance both texture and flavor distribution within the beverages. The precisely adjusted rotating speed and spin curve may further introduce aeration into the mixture, which could be desirable in the preparation of certain beverages. In one further embodiment, the mixing module 40 may support additional or alternative mixing techniques, such as oscillation, shaking and/or stirring, possibly by utilizing a tailored agitator to suit specific beverage requirements. FIG. 9 further illustrated an embodied workflow of the vortex mixing process, showcasing the determination of the predefined spin curve by the software based on the selected recipe and the designated glass type, the transmission of configuration parameters, including such as acceleration, speed limits and deceleration from the remote server 100 to the system 10, and the subsequent execution of the spinning sequence by the mixing module 40. This sequence may involve accelerating, reaching a stable spin speed, and then gradually decelerating to ensure a thorough mixing of the ingredients to form a well blended beverage ready to serve.

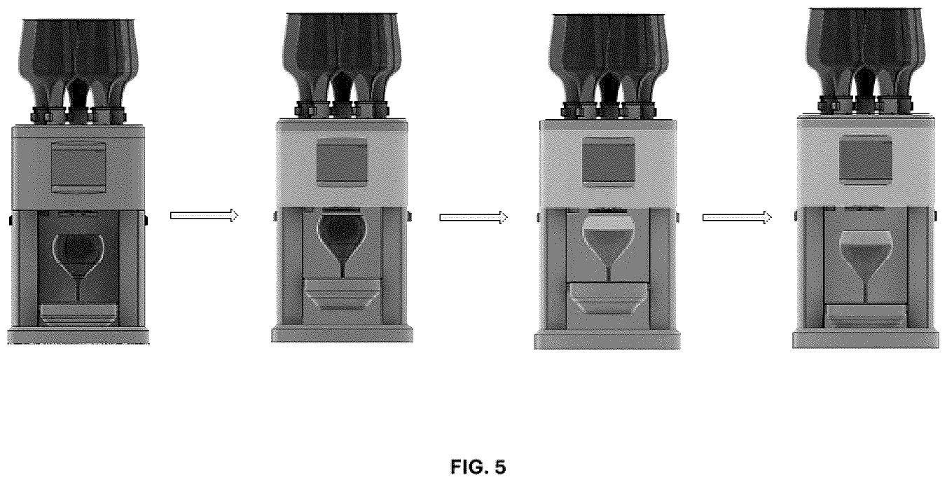

FIG. 5 further illustrates an embodied operation of the dispensing module 30 and the mixing module 40 of the system 10, capturing the gripping, positioning adjustment, and rotation of the designated glassware essential for blending the dispensed liquids into the final beverage.

In one embodiment, the system 10 further comprises a processing module 50 configured to control operation of the system 10, and particularly, functions of the dispensing module 30 and/or the mixing module 40 to enable dynamic adaptations and real-time customizations to selected recipe in response to user inputs and instructions. The processing module 50 is preferably connectable, via the communication module 60, with one or more operator's devices and/or users'devices 110, which can be any computer or mobile devices, for administrative control, operation monitoring and/or user engagement. Via a tailored software platform executable on these devices 110, the system 10 is adapted to receive real-time instructions for machine control and customization, while also facilitating remote performance monitoring and ingredient level tracking. Furthermore, these devices 110, including the operator's devices, may further establish connection with the remote server 100 to access and update the centralized recipe database, allowing integration of new recipes and revisions. Such interconnections not only streamline operational processes but also enable the retrieval and management of customer databases comprising such as user profiles, preferences, order histories, and behavioral patterns. The information supports advanced data analytics for improved operational efficiency and strategic decision making for the system, optimizing the overall user experience and system performance.

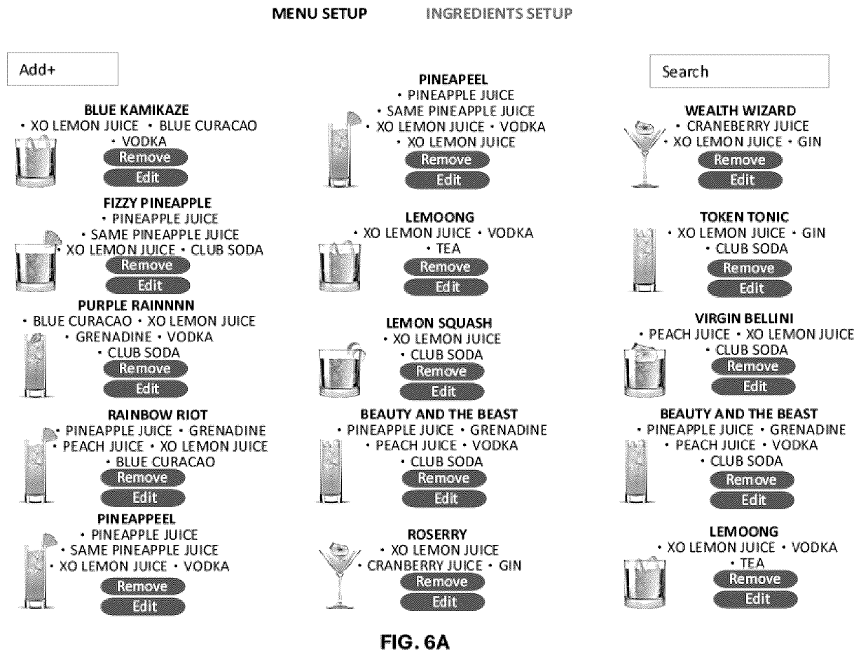

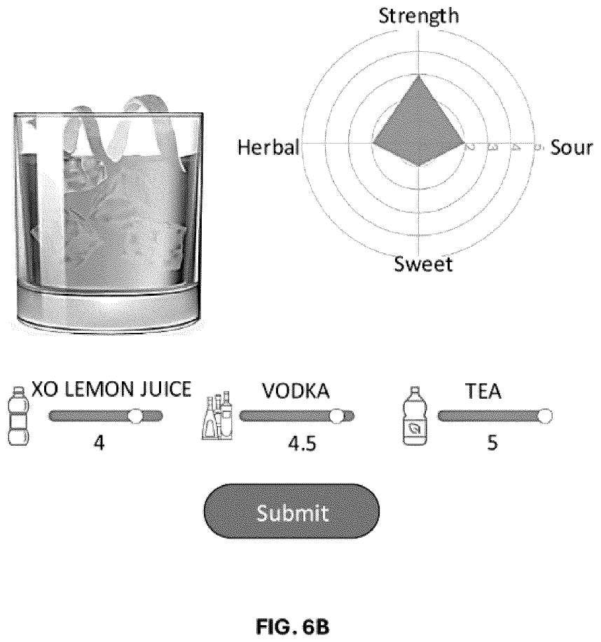

Preferably, the interactive input unit 52, which may preferably comprise a touch-screen interface, serves to receive user instructions to select and/or customize their beverage preferences. FIG. 6A showcases a list of available recipes and customization options displayed on the input unit 52, empowering users to tailor their orders to their liking. In one embodiment, the presented recipes are downloaded from a recipe database 100 by identifying matching recipes that incorporate the ingredients received at the ingredient module 20. In FIG. 6B, shown is an elaborate flavor profile of a selected beverage recipe presenting detailed characteristics like alcohol content and flavor notes such as herbal, sweet, or sour, alongside the ingredient ratios of the recipe. This comprehensive presentation assists customers in making selections that align precisely with their unique tastes, fostering a more personalized and engaging interaction and thus an enhanced user experience.

More preferably, operation of the dispensing module 30 and/or the dispensing module 40 can be controlled by a control unit 54 of the processing module 50. In one embodiment, the control unit 54 is adapted to control operation of the dispensing module 30 by automatically dispensing the selected ingredients at a predetermined dispensing rate, volume and/or sequence according to the selected recipe and/or based on the user's customizations. The control unit 54 may further adapted to control operation of the mixing module 40 by automatically adjusting parameters such as the predetermined speed of rotation and/or the predefined spin curve using the rotating unit 45, and the gripping of the designated beverage container and/or positioning of the designated beverage container by the gripping unit 42 according to the selected recipe and/or the user's customizations. These features allow customers to fine-tune their orders on-the-fly for a truly bespoke experience without interrupting operation of the system or human interventions.

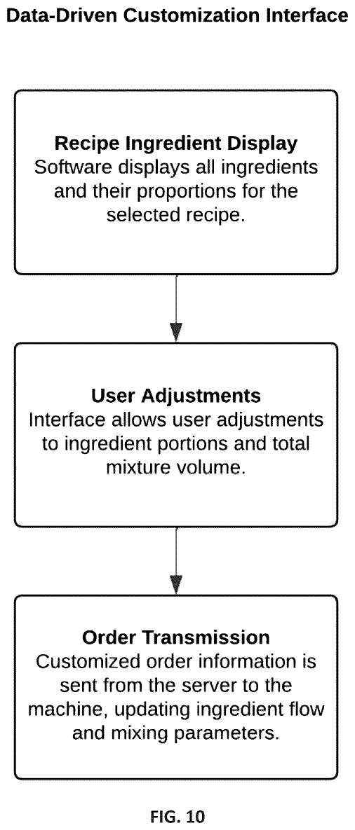

FIG. 10 further illustrates an embodied workflow of the recipe customization process. The process initiates by presenting all ingredients along with their respective ratios or proportions in the selected recipe, allowing users the flexibility to adjust the ingredient ratios and the total mixture volume using the interactive user input 52. Subsequently, the customized order details are transmitted from the remote server 100 to the system 10, triggering updates to ingredient flow rates and mixing parameters.

In one embodiment, the processing module further comprises a predictive unit 56 configured to predict a set of beverage characteristics based on the selected recipe and/or user-specified customization instructions. These characteristics may comprise one or more visual characteristics and/or sensory characteristics. For example, the visual characteristics may include color profile encompassing factors such as hue, clarity or turbidity, color variation and/or color tone, etc. The sensory characteristics may include characteristics such as taste, flavor profiles including such as alcohol content or strength, sweetness levels, bitterness, sourness, saltiness, aroma intensity, flavor balance, texture, mouthfeel, and/or aftertaste, etc. In one further embodiment, the set of characteristics may further extend to comprise other comprehensive characteristics such as nutritional profile, serving temperature, carbonation levels, as well as emotional impacts on customers - ranging from the sensations of calming, energizing, comforting and uplifting, etc. This holistic approach ensures that each customized beverage meets customer expectations, delivering a tailored experience that caters to both sensory delight and emotional satisfaction.

As processed by the predictive unit 56, each ingredient from the ingredient database is firstly assigned with specific values which represent its respective visual, sensory and/or comprehensive characteristics. For example, ingredients can be digitally associated with RGB (red green blue) values for color representation, and taste values such as strength, herbal notes, sourness and sweet levels for flavor profiling. Subsequently, the predictive unit 56 computes these individual values into overall values which represent the visual, sensory and/or comprehensive characteristics expected in the resulting beverage. These computations are based on the preset ratio of selected ingredients from the recipe and/or any user-directed customizations. Following the computation, the predictive unit 56 generates and outputs a detailed profile information of the beverage based on the computed overall values, detailing its visual, sensory and/or other relevant attributes. Preferably, this information can be presented visually, such as through computer generated images or drawings which depict the anticipated final beverage product. This visual representation not only enhances the user experience but also offers a tangible preview of the beverage's appearance along with its flavor composition. By predicting the aesthetic and taste profile of the final beverage product, the predictive unit 56 facilitates user customization while ensuring consistency, particularly in the context of complex recipes. The predictability also provides operators with more accurate preview of recipe adjustments, enabling them to fine-tune formulations to meet expectations and prepare beverages that consistently meets the required standards.

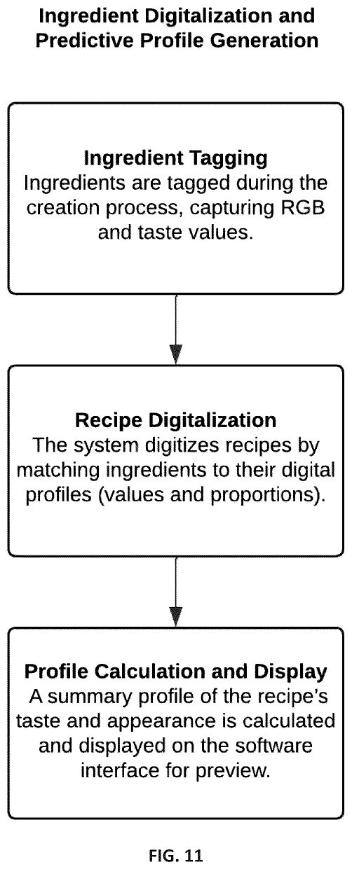

FIG. 11 further illustrates a exemplified workflow of the predictive profile generation process, which comprises ingredient tagging during recipe creation to associate ingredients with their respective values such as RGB values and taste values, digitalization of recipes by aligning ingredients with their values and proportions, and subsequently, calculating overall values for profile information, followed by generating representation of the beverage's appearance, which will be displayed alongside its taste profile on the user input interface for preview.

In one specific embodiment, the processing unit 50 is equipped to process a computer software, and preferably, an artificial intelligence algorithm, for predicting user preferences and/or offering tailored suggestions based on individual user profiles. These profiles encompass a range of information, which can be but are not limited to, user's identification details, background data, consumption history, and/or patterns of selection or adjustments made not only by the specific user but also by similar users or cohorts within the system 10. Through leveraging the AI technology, the processing unit 50 can analyze user profiles, identifying patterns, trends, and correlations that provide insights into individual preferences and behaviors. This analysis enables proactive prediction and personalized recommendations that align closely with each user's unique tastes and requirements.

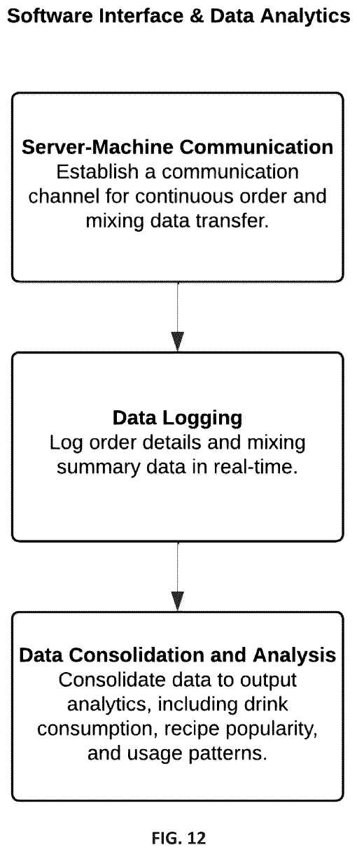

FIG. 12 shows an embodied workflow on the software data analytic process, which comprises the establishment of a communication channel for continuous order and mixing data transfer, real-time logging of order details and mixing summaries, and subsequent data consolidation to generate analytics. These insights may include beverage consumption records, recipe popularity, customer usage patterns and more.

The system 10 supports both direct and online control, enabling remote inventory management, ingredients usage tacking, trend analysis, recipe optimization and real-time monitoring of machine operations. In one embodiment, the system 10 may comprise multiple machines adapted to work independently or collaboratively. The system's capability to connect multiple machines to a central remote server 100 further allows unified control, scalability and remote recipe updates. Various parameters including beverage recipes and operational conditions can be wirelessly managed and updated, facilitating multi-location deployments and streamlining system administration. In one embodiment, the system 10 may further support offline operation, storing data locally in its memory 70 and synchronizing with the remote server 100 when network connectivity is available. Additionally, the system 10 can be configured to support remote customer ordering through online applications, and/or voice control for remote operation of the system 10.

In another aspect of the invention, it relates to a method for the automated preparation of customizable beverages utilizing the system 10. The process initiates with the ingredient module 20 receiving a selection of one or more ingredients, such as ranging from 8-16 different ingredients. The system 10 then searches the recipe database 100 to identify matching recipes that incorporate these ingredients, and presenting these matches on the interactive user interface 52 for user's selection. Customers can then personalize and adjust the recipe in real-time through the processing module 50. According to the selected and/or adjusted recipe, the system 10 is configured to engage and position a designated beverage container via the gripping unit 42, and automatically dispensing a predetermined, precise amount of the selected ingredients into the container through the dispensing module 30. Preferably, the mixing module 40 can dynamically adjust the position of the designated beverage container across one or more axes relative to the dispensing module 30. Additionally, the gripping unit 42 can automatically grasp the designated beverage container based on its type, shape and/or dimension. The dispensing module 30 is adapted to independently dispensing each of the selected ingredients through the corresponding independently operated pumping units 32 at respective flow rates based on the selected recipe to direct a unidirectional flow of the selected ingredient towards the serving container. Subsequently, the mixing module 40 blends the dispensed ingredients by rotating the beverage container at a predetermined speed of rotation under a predefined spin curve, thereby creating a beverage as per the selected recipe.

Furthermore, the method further allows for customization on the dispensing and/or mixing stages by receiving user instruction via the interactive input unit 52. The control unit 54 of the processing module 50 will then control the dispensing process to dispense the selected ingredients at predetermined rates, volumes and/or sequences according to the user's customizations. Similarly, the mixing step can further be automatically customized on parameters such as speed of rotation, spin curve, container grip strength, and/or positioning of the container according to the selected recipe and/or the user's input. Recipes after user's customizations will be stored at the local or remote server for data analytics.

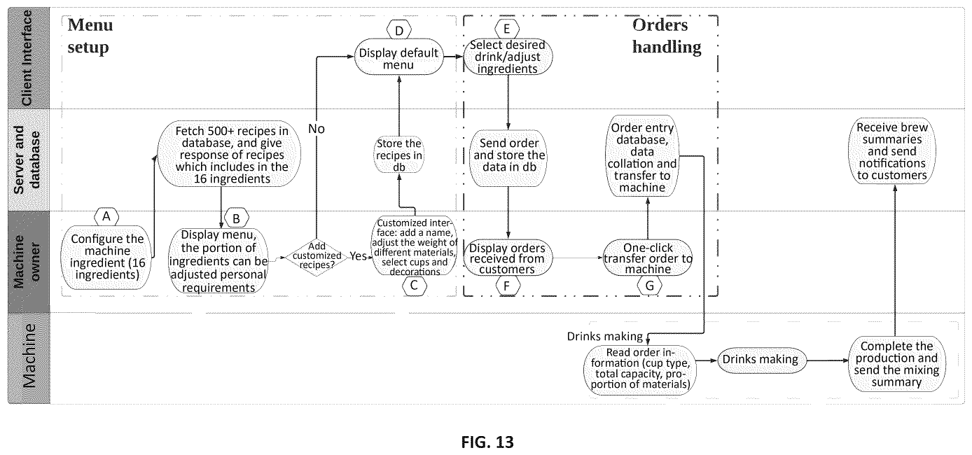

The processing module 50 is further adapted to predict, via a predictive unit 56 of the processing unit 50, characteristics of the beverage to be formed based on the selected recipe and/or the user directives. The prediction involves assigning to each ingredient corresponding values representing the respective visual characteristics and/or sensory characteristics of the ingredient, computing respective overall values representing the visual characteristics and/or the sensory characteristics of the resulting beverage based on the ingredient ratios in the recipe and/or user input, and then outputting a profile information of the beverage based on the computed overall values. The system 10 can then automatically generate and present a visual representation of the beverage for the user's preview. FIG. 13 illustrates an operational flow encompassing machine-level, operator-level, server-level and customer interactions, demonstrating a comprehensive view of the overall process.

In another aspect of the invention, it relates to a computer-implemented method of evaluating or predicting characteristics of beverages. The method comprises providing a database containing one or more recipes, each recipe comprising a preset ratio of one or more ingredients. Each of the one or more ingredients is digitally assigned with corresponding values representing respective one or more visual characteristics and/or sensory characteristics of said ingredient. Subsequently, these values are computed to generate overall values representing the respective visual characteristics and/or the sensory characteristics of the beverage to be formed based on the selected recipe, and a profile information of the beverage will be outputted based on the computed overall values. More preferably, a visual representation of the beverage to be formed will be digitally generated and be displayed to the user based on the profile information of the beverage, offering a comprehensive preview based on the derived profile information.

In one further aspect of the invention, it relates to a computer-implemented system of evaluating or predicting characteristics of beverages. The system comprises a memory for storing data and a processor for executing computer readable instructions. Through the execution of these instructions, the processor is configured by the computer readable instructions to implement the method above described.

In summary, the present invention provides an automated system and method for preparing customizable beverages, particularly but not exclusively, for the crafting of cocktail beverages having multiple ingredients. The system operates in a fully automatic manner, achieving precise and synchronized dispensing of the individual ingredients according to preset or real-time adjustable recipes. The system features containers adaptation to facilitate optimal glass gripping and positioning for ingredients dispensing and blending, allowing an effective vortex mixing of the diverse ingredients by controlled rotation of the container specific to the selected cocktail recipe to form a cocktail readily mixed in the serving glass. Furthermore, the system allows real-time customization of recipes in real-time, enabling on-the-fly adjustments to ingredients and/or preparation parameters through an interactive user interface without interrupting the system's operation or any human interventions. More particularly, the system is adapted to predict various characteristics, such as visual and/or sensory attributes of the prepared beverages, for beverages under both the standard recipes and the customized recipes. In one embodiment, the system further provides visual depictions of the prepared beverages, assisting in accurate forecasting and visualization of the final beverage product. The system's fully automated glassware positioning and adaptation, real-time recipe customization, and predictive profiling of appearance and taste collectively offer high-quality, personalized services which are appealing to customers. Automated ingredient control and remote online management further enable it for serving high-traffic venues, ensuring consistency, reliability and labor efficiency. Moreover, the system further adapts in preparing complex, visually appealing customized drinks such as layered cocktails to offer a unique, data-driven and highly efficient beverage preparation experience. The present invention finds utility in diverse settings, spanning from home environments to commercial establishments like hotel chains, bars, and restaurants. Its user-friendly interface makes it equally accessible for domestic use, underscoring its versatility and broad applicability.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

Thus, for example, it will be appreciated by those skilled in the art that the diagrams presented herein represent conceptual views of components embodying the principles of the invention.

It is to be understood that, if any prior art publication is referred to herein, such reference does not constitute an admission that the publication forms a part of the common general knowledge in the art.

What is claimed is:

1. An automated system for preparing customizable beverages, comprising:
an ingredient module for receiving one or more ingredients, the ingredient module comprises one or more receptacles for adaptively receiving and positioning respective ingredient containers of the one or more ingredients;
a dispensing module fluidly connectable with the ingredient module, the dispensing module is configured to automatically dispense a predetermined amount of one or more selected ingredients from the one or more ingredients into a designated beverage container based on a selected recipe;
a mixing module for securely engaging and positioning the designated beverage container, the mixing module comprises a rotating unit adapted to rotate the engaged and positioned beverage container at a predetermined speed of rotation under a predefined spin curve, thereby mixing the dispensed selected ingredients to form a beverage in the beverage container according to the selected recipe; and
a processing module configured to control operation of the dispensing module and/or the mixing module thereby providing real-time customizations to the selected recipe based on user instructions.

2. The automated system according to claim 1, wherein the mixing module is adapted to automatically adjust positioning of the designated beverage container by moving in one or more three-dimensional axes relative to the dispensing module for receiving the dispensed ingredients.

3. The automated system according to claim 1, wherein the mixing module comprises a gripping unit adapted to snugly grip the designated beverage container automatically according to shape and/or dimension of the designated beverage container.

4. The automated system according to claim 3, wherein the gripping unit comprises a plurality of movable segments extending radially from a substantially circular frame whereby the designated beverage container is positioned, the segments are movable automatically between an open position at which one or more segments are retractable radially outwardly towards the frame, and a close position at which the one or more segments are extendable radially inwardly towards a centre of the frame to grip onto the designated beverage container.

5. The automated system according to claim 1, wherein the dispensing module comprises one or more independently operated pumping units adapted to dispense the corresponding one or more selected ingredients at respective flow rates based on the selected recipe.

6. The automated system according to claim 5, wherein the pumping unit is adapted to dispense the respective selected ingredient based on a peristaltic pumping action to direct a unidirectional flow of the selected ingredient towards the beverage container.

7. The automated system according to claim 1, wherein the processing module comprises:
an input unit for receiving the user instruction;
a control unit, wherein the control unit is adapted to control:
operation of the dispensing module by automatically dispensing the one or more selected ingredients at a predetermined rate, volume and/or sequence according to the selected recipe and/or the user instruction; and/or
operation of the mixing module by automatically adjusting one or more of the predetermined speed of rotation, the predefined spin curve, the gripping of the designated beverage container, and/or positioning of the designated beverage container according to the selected recipe and/or the user instruction.

8. The automated system according to claim 7, wherein the processing module further comprises a predictive unit configured to predict a set of characteristics of the beverage to be formed based on the selected recipe and/or the user instruction, wherein the set of characteristics comprises one or more visual characteristics, sensory and/or comprehensive characteristics.

9. The automated system according to claim 8, wherein each ingredient of the one or more ingredients is assigned with corresponding values representing the respective visual characteristics, sensory characteristics and/or comprehensive characteristics of the ingredient.

10. The automated system according to claim 9, wherein the predictive unit is adapted to compute respective overall values representing the visual characteristics, sensory characteristics and/or comprehensive characteristics of the beverage to be formed based on a preset ratio of the one or more selected ingredients of the selected recipe and/or the user instruction, and to output a profile information of the beverage based on the computed overall values.

11. The automated system according to claim 10, wherein the predictive unit is adapted to display a visual presentation of the beverage to be formed based on the profile information of the beverage.

12. A method of automatically preparing customizable beverages according to the system of claim 1, comprising the steps of:
receiving one or more ingredients via an ingredient module;
according to a selected recipe, engaging and positioning a designated beverage container via a mixing module;
dispensing automatically, via a dispensing module fluidly connectable with the ingredient module, a predetermined amount of one or more selected ingredients from the one or more ingredients into the designated beverage container based on the selected recipe;
mixing, via a mixing module, the dispensed selected ingredients by rotating the engaged and positioned beverage container at a predetermined speed of rotation under a predefined spin curve, thereby forming a beverage in the beverage container according to the selected recipe; and
wherein the dispensing step and/or the mixing step are customizable in real-time via a processing module based on user instructions.

13. The method according to claim 12, wherein the engaging and positioning step comprises automatically adjusting position of the designated beverage container by moving in one or more three-dimensional axes relative to the dispensing module.

14. The method according to claim 12, wherein the engaging and positioning step comprises automatically gripping, by a gripping unit of the mixing module, the designated beverage container according to shape and/or dimension of the designated beverage container.

15. The method according to claim 12, wherein the dispensing step comprises independently dispensing the one or more selected ingredients from corresponding one or more independently operated pumping units of the dispensing module at respective flow rates based on the selected recipe to direct a unidirectional flow of the selected ingredient towards the designated beverage container.

16. The method according to claim 12, further comprising a step of customizing the dispensing and/or mixing steps, customizing step comprises:
receiving a user instruction via an input unit; and
controlling, via a control unit of the processing module, the dispensing step to dispense automatically the one or more selected ingredients at a predetermined rate, volume and/or sequence according to the received user instruction; and/or the mixing step to automatically adjust one of more of the predetermined speed of rotation, the predefine spin curve, gripping of the designated beverage container, and/or positioning of the designated beverage container according to the selected recipe and/or the user instruction.

17. The method according to claim 12, further comprising a step of predicting, via a predictive unit of the processing unit, a set of characteristics of the beverage to be formed based on the selected recipe and/or the user instruction, wherein the set of characteristics comprises one or more visual characteristics and/or sensory characteristics.

18. The method according to claim 17, wherein the step of predicting comprises assigning to each ingredient of the one or more ingredients corresponding values representing the respective visual characteristics and/or sensory characteristics of the ingredient.

19. The method according to claim 18, wherein the step of predicting comprises computing respective overall values representing the visual characteristics and/or the sensory characteristics of the beverage to be formed based on a preset ratio of the one or more selected ingredients of the selected recipe and/or the user instruction, and outputting a profile information of the beverage based on the computed overall values.

20. The method according to claim 19, wherein the predicting step further comprises displaying a visual presentation of the beverage to be formed based on the profile information of the beverage.
